(19) United States
(12) Patent Application Publication
(10) Pub. No.: US 2011/0198845 A1
(43) Pub. Date: Aug. 18, 2011

(54) BOX CULVERT GASKET SEAL

(75) Inventor: Austin Charles LaFleur, Hudson, OH (US)

(73) Assignee: Universal Polymer & Rubber Ltd.

(21) Appl. No.: 12/708,187

(22) Filed: Feb. 18, 2010

(51) Int. Cl. F16J 15/06; F16J 15/10; F16L 21/035; F16L 21/02

(52) U.S. Cl. 285/374; 277/612

(57) ABSTRACT

A gasket for use in a bell-and-spigot joint between adjacent concrete box culverts. The gasket includes a body portion having top and bottom surfaces and opposing longitudinal edges. A first protrusion extends from the top surface adjacent one longitudinal edge, and a second protrusion extends from the top surface adjacent the other longitudinal edge. A layer of pressure-sensitive adhesive covers at least a portion of the bottom surface. The protrusions provide sealing contact points between the box culverts.

### TECHNICAL FIELD

This invention relates to a gasket for sealing a joint between two adjacent box culverts to create a soil tight and drip proof seal. More particularly, this invention relates to such a gasket including a unique geometry to provide a better seal, and a pre-applied pressure sensitive adhesive to facilitate easier installation. In certain embodiments, this invention also relates to a box culvert joint assembly including a gasket.

### BACKGROUND ART

Box culverts are typically used to form relatively large underground sewers and storm drains. These box culverts are made of concrete, and several box culverts are joined together to create a sewer or storm drain. A joint is formed between adjacent box culverts to secure the adjacent units together and to prevent the transfer of fluids from the exterior of the sewer or storm drain to the interior, or vice versa.

The box culverts have a generally rectangular profile and often have a width of up to fourteen feet and a height of up to ten feet, although the box culverts may be provided in any desired size. Each box culvert also has a length of at least several feet. Assembling a plurality of box culverts to form a sewer or storm drain is a cumbersome process due to the relatively large size and weight of the concrete box culverts. Adjacent box culverts must be precisely aligned in order to form an effective joint. In addition, a gasket must be installed between the adjacent box culverts in order to provide the desired seal therebetween.

Known box culvert gaskets and sealing methods are ineffective in meeting current performance requirements. Conventional practice includes installing a preformed flexible mastic material having either a bituminous or butyl rubber base at the joint. An adhesive cement is often used to secure the gasket in place, which may require clamping of the gasket until the adhesive sets. In addition to being difficult and time consuming to install, this known type of gasket does not always meet the performance requirement of current industry standards, and is subject to degradation over time making the gasket even less effective.

Thus, there is a need for an improved box culvert gasket and sealing assembly to ease installation and provide better performance over the life of the gasket.

### DISCLOSURE OF THE INVENTION

It is thus an object of one aspect of the present invention to provide a box culvert gasket having a unique geometry to provide a dual-sealing function.

It is an object of another aspect of the present invention to provide a box culvert gasket, as above, including a pre-applied pressure sensitive adhesive layer on at least one surface thereof to secure the gasket to a box culvert. It is an object of an additional aspect of the present invention to provide a box culvert gasket, as above, that provides improved performance when installed in a box culvert joint.

It is an object of yet another aspect of the present invention to provide a box culvert gasket, as above, that is adapted to be used in conjunction with standard tongue and groove joints of box culverts.

These and other objects of the present invention, as well as the advantages thereof over existing prior art forms, which will become apparent from the description to follow, are accomplished by the improvements hereinafter described and claimed.

In general, a box culvert gasket according to the concepts of the present invention includes a body portion having a bottom surface, a top surface, a first longitudinal edge and a second longitudinal edge. A first protrusion extends from the top surface of the body portion adjacent the first longitudinal edge and a second protrusion extends from the top surface of the body portion adjacent the second longitudinal edge.

In accordance with at least one aspect of the present invention, a box culvert gasket includes a spigot extending from a first box culvert, a bell within a second box culvert, and a gasket positioned around the periphery of the spigot. The gasket has a body portion including a bottom surface and a top surface. The gasket also includes a first protrusion extending from the top surface, and a second protrusion extending from the top surface and laterally spaced from the first protrusion.

In accordance with at least one aspect of the present invention, a box culvert gasket includes a spigot extending from a first box culvert, a bell within a second box culvert, and a gasket positioned around the periphery of the spigot and within the bell to form a seal therebetween. The gasket has a body portion with a top surface and a bottom surface. The gasket also includes a first protrusion extending from the top surface, a second protrusion extending from the top surface and laterally spaced from the first protrusion, and a layer of pressure-sensitive adhesive positioned over at least a portion of the bottom surface. The adhesive acts to secure the gasket to the first box culvert, and the first and second protrusions each contact the second box culvert to provide a dual seal in the joint.

A preferred exemplary box culvert gasket according to the concepts of the present invention is shown by way of example in the accompanying drawings without attempting to show all the various forms and modifications in which the invention might be embodied, the invention being measured by the appended claims and not by the details of the specification.

### BRIEF DESCRIPTION OF THE DRAWINGS

FIG. 1 is a perspective view of adjacent box culverts including a gasket according to the concepts of the present invention.

FIG. 2 is a fragmentary sectional view of a portion of a box culvert joint.

FIG. 3 is a fragmentary sectional view of the box culvert joint of FIG. 2 including a gasket according to the concepts of the present invention.

FIG. 4 is a fragmentary sectional view of the box culvert joint shown in FIG. 2, wherein the adjacent box culverts have been joined together.

FIG. 5 is a sectional view of a box culvert gasket as shown in made in accordance with the present invention.

FIG. 6 is a sectional view of an alternate embodiment of the box culvert gasket.

FIG. 7 is a fragmentary sectional view of a box culvert joint including the gasket of FIG. 6.

FIG. 8 is a sectional view of another embodiment of a gasket.

FIG. 9 is a sectional view of still another embodiment of a gasket.

### PREFERRED EMBODIMENTS FOR CARRYING OUT THE INVENTION

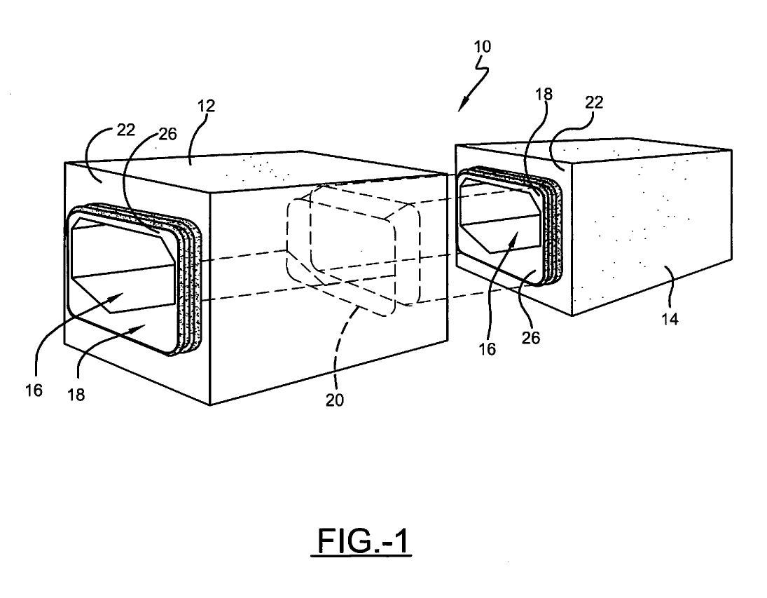

A box culvert assembly constructed and assembled in accordance with the present invention is indicated generally by the numeral 10. Box culvert assembly 10 (FIG. 1) includes adjacent box culverts 12 and 14 that are adapted to be secured together. Each box culvert 12, 14 is generally rectangular in shape and includes an inner channel 16 therethrough. The adjacent box culverts 12, 14 are joined by a bell-and-spigot joint, which includes a spigot 18 extending outwardly from a face of one box culvert 14, and a corresponding bell 20 formed in the face of the other box culvert 12. The bell-and-spigot joint may also be referred to as a tongue and groove joint, with the tongue (spigot) being received in a groove (bell).

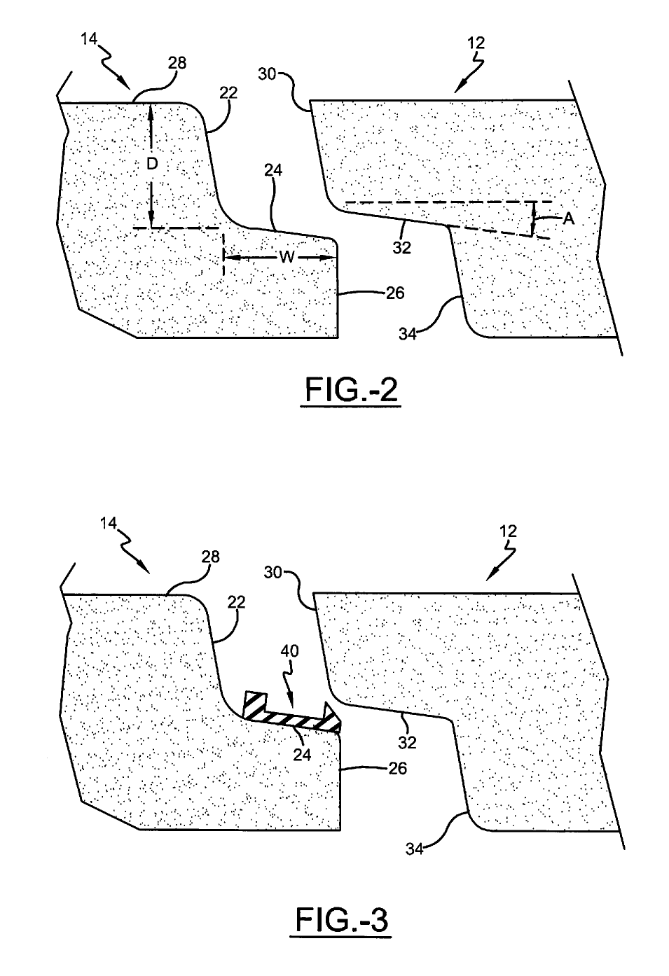

Each spigot 18 extends from a first end 22 of a box culvert 12, 14 surrounding an opening of inner channel 16. Spigot 18 includes an outer radial surface 24 and an end face 26 (FIG. 2). Outer radial surface 24 may have a width W of between approximately five and six inches. The radial distance D between outer radial surface 24 and an outer surface 28 of box culvert 14 may be approximately five inches. It will be appreciated by those skilled in the art, that the dimensions discussed herein may be altered without deviating from the scope of the present invention.

A second end 30 of each box culvert 12, 14 includes a bell 20 (FIG. 1) adapted to receive spigot 18 therein. Bell 20 includes an inwardly extending radial surface 32 and an end face 34 (FIG. 2). Bell 20 has a complimentary shape to spigot 18, and the dimensions thereof may be adjusted depending upon the dimensions of the opposing spigot. The inwardly extending radial surface 32 of bell 20 and the outer radial surface 24 may each be set at an angle A from horizontal to facilitate positioning and joining of box culverts 12, 14. In certain embodiments of the invention, the angle of taper A may be approximately ten degrees.

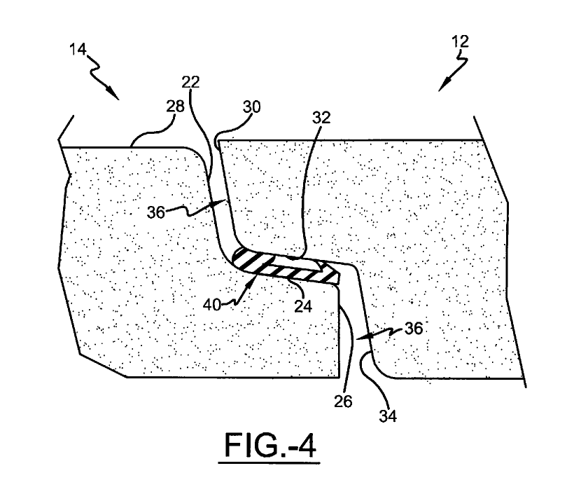

Spigot 18 and bell 20 are sized and shaped such that, when box culverts 12, 14 are joined together, a gap 36 exists therebetween (FIGS. 4 and 6). Gap 36 is generally “S” shaped and extends from the outer radial surface of the box culverts to the inner surface defining the inner channel 16. Thus, without a gasket positioned within the gap, a passageway would be provided from the exterior to the interior of the sewer or storm drain created by the box culverts. Gap 36 provides a space between first end 22 and second end 30 of box culverts 12 and 14, between outer radial surface 24 of spigot 18 and inwardly extending radial surface 32 of bell 20 and between end face 26 of spigot 18 and end face 34 of bell 20. The distance between the adjacent surfaces of box culverts 12 and 14 created by gap 36 may be approximately 0.5 inches. It will be appreciated, however, that the distance of separation created by gap 36 will vary slightly due to the angle of taper of inwardly extending radial surface 32, and due to curved intersections between the surfaces of the box culverts.

Referring now to FIGS. 3-5, a gasket according to the concepts of the present invention is indicated generally by the numeral 40. Gasket 40 may be provided in the form of an elongated strip or tape. Gasket 40 may be made of an elastomeric material or a PVC nitrile, or may be formed of a closed-cell sponge or dense rubber. It will be appreciated by those skilled in the art, however, that other known materials may provide the desired deformability and longevity as contemplated by the present invention.

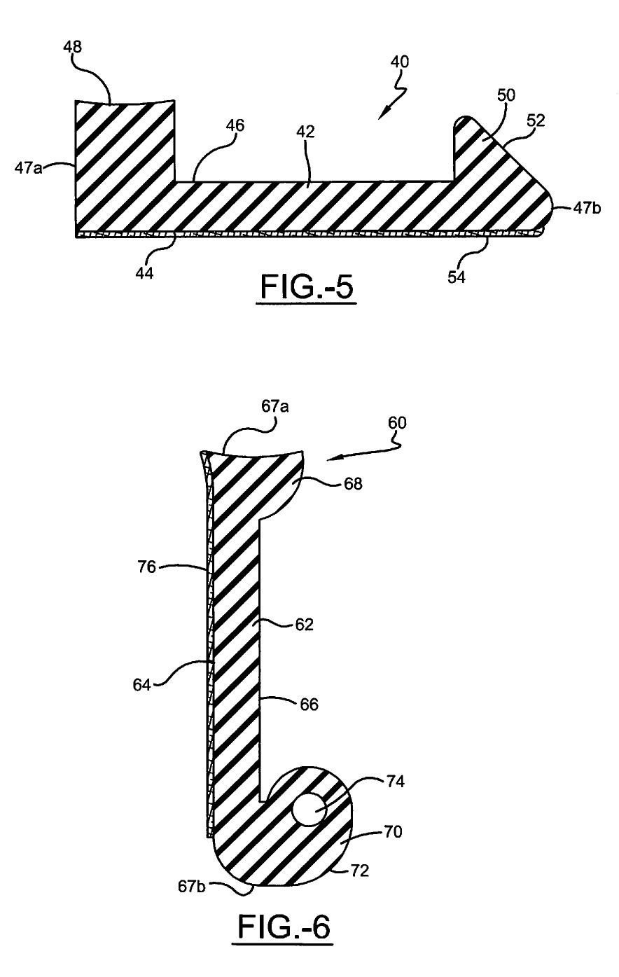

Gasket 40 includes a body portion 42 having a bottom surface 44 and a top surface 46 (FIG. 5). Body portion 42 has a generally rectangular sectional profile, and may have a total width between the opposing longitudinally extending edges 47a, 47b of between approximately 3.0 and 4.0 inches. A first protrusion 48 extends upwardly from top surface 46 adjacent one longitudinal edge 47a of body portion 42, and a second protrusion 50 extends upwardly from top surface 46 adjacent the other longitudinal edge 47b of body portion 42. First protrusion 48 may have a generally rectangular profile. Second protrusion 50 includes an angled surface 52 facing away from first protrusion 48. A pressure-sensitive adhesive layer 54 is pre-applied over at least a portion of bottom surface 44.

First protrusion 48 may extend from top surface 46 a maximum distance of between approximately 0.5 inches and 1.0 inches. Similarly, second protrusion 50 may extend from top surface 46 a maximum distance of between approximately 0.5 and 1.0 inches. First protrusion 48 and second protrusion 50 may extend from top surface 46 an equal distance, or they may extend different distances.

Gasket 40 is positioned around the outer radial surface 24 of spigot 18 prior to the joining of box culverts 12, 14 (FIG. 3), and is secured in place by the pressure-sensitive adhesive 54 that is pre-applied on the bottom surface of the gasket. As spigot 18 is inserted into bell 20, second protrusion 50 is compressed by the inwardly extending radial surface 32 of bell 20 (FIG. 4). Angled surface 52 of second protrusion 50 may be lubricated during installation to facilitate insertion of spigot 18 into bell 20 and reduce friction between angled surface 52 and radial surface 32. When spigot 18 has been fully inserted into bell 20, second protrusion 50 is compressed between outer radial surface 24 and inwardly extending radial surface 32, and may also be compressed between first end 22 of box culvert 14 and second end 30 of box culvert 12 (not shown). Thus, the geometry of gasket 40 provides two separate sealing interfaces via first protrusion 48 and second protrusion 50.

An alternate embodiment of a gasket made in accordance with the present invention is shown in FIG. 6 and is indicated generally by the numeral 60. Gasket 60 includes a body portion 62 having a bottom surface 64 and a top surface 66, similar to gasket 40. Gasket 60 also includes a first protrusion 68 extending from top surface 66 adjacent a first longitudinal edge 67a of body portion 62 and a second protrusion 70 extending from top surface 66 adjacent a second longitudinal edge 67b of body portion 62. The profile of first protrusion 68 includes an outwardly curved portion facing the interior of body portion 62 and a generally planar edge adjacent to the edge of body portion 62. Second protrusion 70 is generally spherical shape and includes a curved surface 72 that extends from bottom surface 64 of body portion 62. Second protrusion 70 also includes a bore 74 therethrough, which facilitates the compression and deformation thereof. Gasket 60 is also provided with a pressure-sensitive adhesive layer 76 on at least a portion of bottom surface 64.

First protrusion 68 may extend from top surface 66 a maximum distance of between approximately 0.5 inches and 1.0 inches. Similarly, second protrusion 70 may extend from top surface 66 a maximum distance of between approximately 0.5 and 1.0 inches. First protrusion 68 and second protrusion 70 may extend from top surface 66 an equal distance, or they may extend different differences.

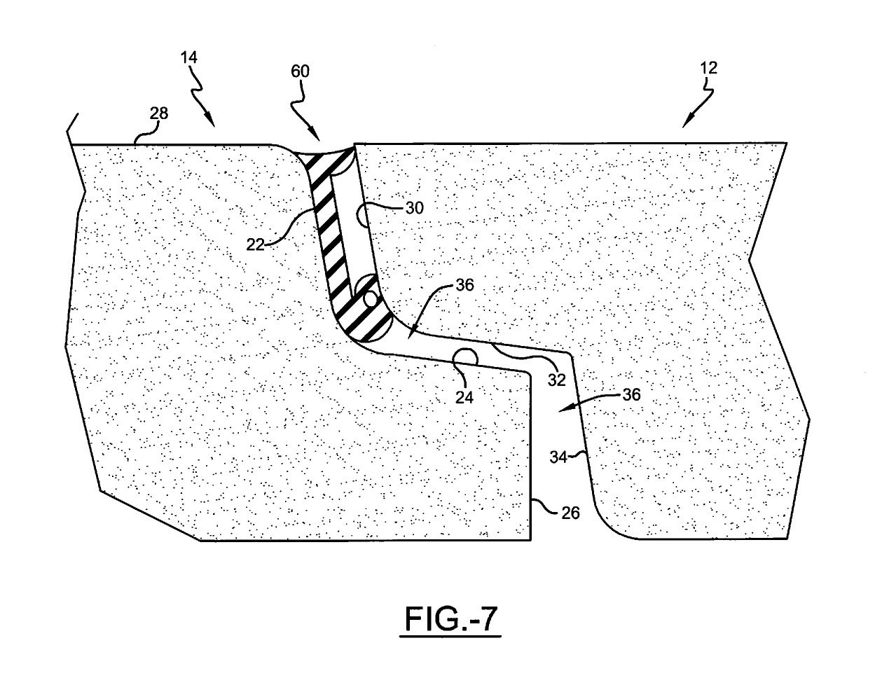

Gasket 60 is positioned around spigot 18 with bottom surface 64 adjacent to and facing first end 22 of box culvert 14 (FIG. 7). Gasket 60 is secured on first end 22 by the pressure-sensitive adhesive layer 76. When so positioned, the second protrusion 70 of gasket 60 is positioned adjacent to the outer radial surface 24 of spigot 18, and first protrusion 68 is positioned adjacent to the outer radial surface 28 of box culvert 14. When adjacent box culverts 12, 14 are joined together, with spigot 18 being received in bell 20, first protrusion 68 is compressed between first end 22 of box culvert 14 and second end 30 of box culvert 12. At the same time, second protrusion 70 is compressed at the intersection of the outer radial surface 24 of spigot 18 and the first end 22 and the inwardly extending radial surface 32 of bell 20 and the second end 30. Body portion 62 of gasket 60 is located within gap 36 between first end 22 and second end 30 of box culverts 14, 12, respectively. Like gasket 40, gasket 60, when positioned in a joint between adjacent box culverts as described above, provides two separate sealing locations to protect against water and dirt infiltration.

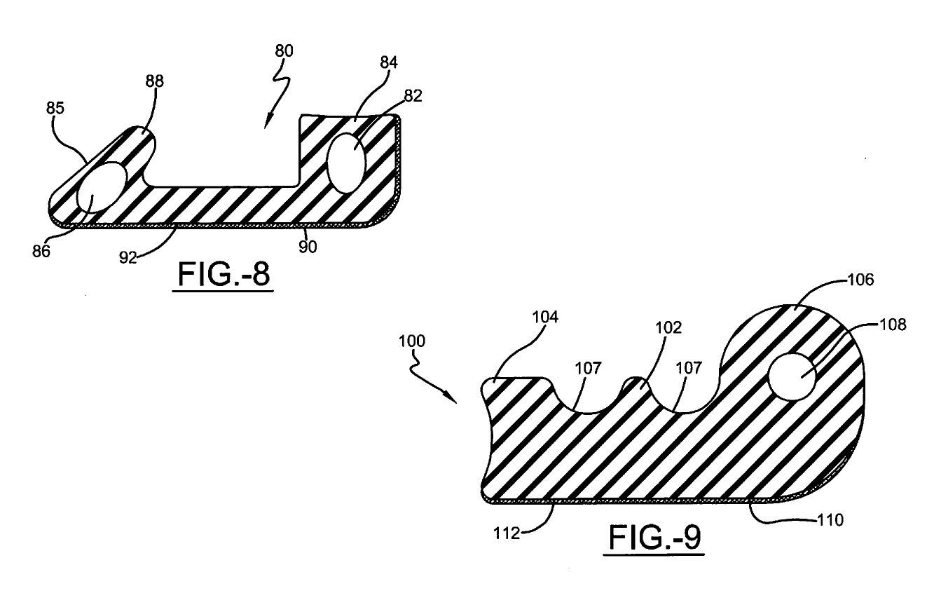

Another alternate embodiment of a gasket according to the concepts of the present invention is shown in FIG. 8 and is indicated generally by the numeral 80. Gasket 80 is similar in most respects to gasket 40, including the first and second protrusions 84, 88 and the angled surface 85. Gasket 80 differs, however, in that it includes a bore 82 through first protrusion 84 and a bore 86 through second protrusion 88. Gasket 80 includes a layer of pressure-sensitive adhesive 90 on a bottom surface 92 thereof. The layer of pressure-sensitive adhesive 90 may optionally extend upward along an outer surface of first protrusion 84. Gasket 80 is installed in a manner like gasket 40, described above, and functions in the same way. Bores 82 and 86 may help to allow first and second protrusions 84 and 88 to deform to the contours of the box culvert joint.

Another embodiment of the gasket according to the concepts of the present invention is shown in FIG. 9 and is indicated generally by the numeral 100. Gasket 100 is similar in most respects to gasket 60 previously described. However, gasket 100 further includes a third protrusion 102 positioned between first protrusion 104 and second protrusion 106. Unlike gasket 60, first protrusion 104 has a generally rectangular profile. A generally curvilinear transition 107 is provided between first protrusion 104, third protrusion 102 and second protrusion 106. Thus, the profile or section view of gasket 100 has a wave-like upper surface. Like gasket 60, gasket 100 includes a bore 108 through second protrusion 106, and a layer of pressure-sensitive adhesive 110 along a bottom surface 112 of gasket 100. Gasket 100 is secured around spigot 18 by the pressure-sensitive adhesive layer 110, which adheres to first end 22 adjacent to spigot 18. Gasket 100 is installed and functions similar to gasket 60, discussed above, except that a third sealing contact is provided between first end 22 and second end 30 by third protrusion 102.

It is thus evident that a box culvert gasket constructed as described herein accomplishes the objects of the present invention and otherwise substantially improves the art.

What is claimed is:

1. A gasket for use in a tongue and groove joint between adjacent concrete box culverts comprising a body portion having a bottom surface, a top surface, a first longitudinal edge and a second longitudinal edge; a first protrusion extending from said top surface of said body portion adjacent said first longitudinal edge; and a second protrusion extending from said top surface of said body portion adjacent said second longitudinal edge.

2. The gasket of claim 1, further comprising a layer of pressure-sensitive adhesive covering at least a portion of said bottom surface of said body portion.

3. The gasket of claim 1, wherein said first protrusion extends from said top surface a distance of between approximately 0.5 and 1.0 inches.

4. The gasket of claim 1, wherein said second protrusion extends from said top surface a distance of between approximately 0.5 and 1.0 inches.

5. The gasket of claim 1, wherein the gasket is made of PVC nitrile.

6. The gasket of claim 1, wherein the gasket is made of a closed-cell sponge.

7. The gasket of claim 1, wherein said second protrusion includes an angled surface facing away from said first protrusion.

8. The gasket of claim 1, where said second protrusion has a generally elliptical profile.

9. The gasket of claim 8, wherein said second protrusion includes a bore extending longitudinally therethrough.

10. A bell-and-spigot joint assembly between adjacent box culverts comprising a spigot extending from a first box culvert, a bell within a second box culvert, and a gasket positioned around the periphery of the spigot, said gasket having a body portion including a bottom surface and a top surface, a first protrusion extending from said top surface, and a second protrusion extending from said top surface and spaced from said first protrusion.

11. The box culvert joint assembly of claim 10, further comprising a layer of pressure-sensitive adhesive on at least a portion of said bottom surface of said body portion of said gasket.

12. The box culvert joint assembly of claim 10, wherein said first and second protrusions each extend from said top surface a distance of between approximately 0.5 and 1.0 inches.

13. The box culvert joint assembly of claim 10, wherein said gasket is made of [commercial embodiment?].

14. The box culvert joint assembly of claim 10, wherein said second protrusion includes an angled surface facing away from said first protrusion.

15. The box culvert joint assembly of claim 14, said gasket being secured by an adhesive to an outer radial surface of said spigot with said angled surface facing toward said second box culvert and said bell.

16. The box culvert joint assembly of claim 10, wherein said second protrusion has a generally elliptical profile and includes a bore extending therethrough.

17. The box culvert joint assembly of claim 16, said gasket being secured by an adhesive to an end face of said first box culvert with said second protrusion positioned adjacent to an outer radial surface of said spigot.

18. A bell-and-spigot joint assembly between adjacent box culverts comprising a spigot extending from a first box culvert, a bell within a second box culvert, and a gasket positioned around the periphery of the spigot and within the bell to form a seal therebetween, said gasket having a body portion with a top surface and a bottom surface, a first protrusion extending from said top surface, a second protrusion extending from said top surface and laterally spaced from said first protrusion, and a layer of pressure-sensitive adhesive positioned over at least a portion of said bottom surface, said adhesive securing said gasket to said first box culvert, wherein said first and second protrusions each contact said second box culvert to provide a dual seal in the joint.
